(19) United States
(12) Patent Application Publication
(10) Pub. No.: US 2004/0003378 A1
(43) Pub. Date: Jan. 1, 2004

(54) Method and system providing access to application running on simulated system

(76) Inventors: Bryan J. Jacquot, Windsor, CO (US); Cheryl L. Herndon, Fort Collins, CO (US); Aland B. Adams, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/187,647

(22) Filed: Jul. 1, 2002

(51) Int. Cl. G06F 9/45

(52) U.S. Cl. 717/137

(57) ABSTRACT

A system for providing access to an application running on a computer simulation. The system has a first computing device that has a simulation program for simulating a second computing device. On top of the simulation program, the first computing device runs a software application that normally executes on the hardware of the second computing device. The first computing device also grants access to multiple users simultaneously to separate instantiations of the simulation software program and the software application.

### TECHNICAL FIELD

The present invention relates to the field of computer systems. Specifically, embodiments of the present invention relate to a method and system for providing access to an application program running on top of a simulation of another computer system.

### BACKGROUND ART

When customers are contemplating purchasing a computer system and associated software applications, the customers would like an opportunity to see the software applications in operation. This allows the customers a chance to judge the quality of the software first hand. Furthermore, customers who have already purchased or are about to purchase computer hardware and associated software may wish to train their employees to use and manage the software. For example, a corporation will want its system administrators to manage a newly purchased system effectively from the day it is installed.

However, demonstrating the software application for training or sales purposes frequently presents considerable obstacles. It is often not practical to install the full computer system at the customer's site, as the computer system may be a million dollar or even multi-million dollar high-end machine. Alternatively, the computer system may be set up at the manufacturer's site and customers brought in to see a live demonstration. Clearly, this option is very expensive and time consuming for both the customer and the manufacturer. Also, the computer system may have a myriad of possible configurations and it is very time consuming to make changes to the configuration of the computer system.

Furthermore, due to the nature of some software applications, only one or a very limited number of instantiations may be running simultaneously on one machine. For example, this may be the case with applications that deal with the management of the computer system itself. However, frequently the customer wants to train perhaps 20 employees at the same time. For the best learning experience, each employee should be able to explore the software application on their own. However, this is not possible if only one (or even a few) instantiations of the application can run at one time.

One conventional solution to providing access to a software application is to provide static screen shots of the application. This is clearly very limited in its training and sales effectiveness. For example, the customer or student cannot experience the application as it will be actually used and is a passive learner.

A step up from static screen shots are movie demonstrations. However, these do not allow the customer the opportunity to actively participate in the learning or sales experience. For example, the customer or student cannot click on icons and cause the application to perform as it will in the real world.

Another conventional method of demonstrating application software is via an Internet hook-up that allows the customer to see what is happening at the manufacturer's site. For example, the manufacturer runs the demonstration from their site with every participant passively watching the demonstration. Again, the customers do not get a chance to explore the application on their own and every customer is forced to go through the same demonstration even if some would prefer a different pace or focus. Furthermore, the machine that is running the demonstration may need to be dedicated to the demonstration. If this is an expensive machine, considerable resources are tied up.

Thus, one problem with conventional methods and systems for providing customers access to a software application is that the customers may not have the hardware on which the application is designed to run. Another problem with such methods and systems is the cost is setting up the hardware either locally or remotely to demonstrate the software application. Still another problem is the time and cost involved with modifying the configuration of the hardware such that the application may be demonstrated under various hardware configurations. Another problem with such methods and systems is the limited effectiveness of techniques in which the customer or student is a passive participant. Still another problem is that all customers/students must share the same demonstration.

### DISCLOSURE OF THE INVENTION

The present invention pertains to a system for providing access to an application running on a computer simulation. The system has a first computing device that has a simulation program for simulating a second computing device. On top of the simulation program, the first computing device runs a software application that normally executes on hardware of the second computing device. The first computing device also grants access to multiple users simultaneously to separate instantiations of the simulation software program and the software application.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a system for providing access to a computer simulation, according to an embodiment of the present invention.

FIG. 2 is a screen shot of an exemplary configuration of a hardware partition in a simulated environment, according to an embodiment of the present invention.

FIG. 3 is a flowchart illustrating steps of a process of providing access to a computer simulation, according to an embodiment of the present invention.

FIG. 4 is an exemplary computer system that may serve as a platform for embodiments of the present invention.

### DETAILED DESCRIPTION OF THE INVENTION

In the following detailed description of embodiments of the present invention, a method and system for providing access to an application running on a computer simulation, numerous specific details are set forth in order to provide a thorough understanding of the present invention. However, embodiments of the present invention may be practiced without these specific details or by using alternate elements or methods. In other instances well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting”, “instantiating”, “receiving”, “computing”, “initiating”, “modifying”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical and mechanical computers.

A hardware partitioning application may be for allowing system administrators to configure computer systems that support hardware partitions. In this fashion, a computer system may be divided into partitions, which each run a separate operating system. Embodiments of the present invention allow customers and students access to an actual hardware partitioning program without requiring that the hardware partitioning program be run on an actual high-end computer system.

In one embodiment of the present invention, a high-end computer system is simulated on a low-end computer system. The low-end system also runs a hardware partitioning application on the simulated high-end system. In this fashion, it appears that the hardware partitioning application is running on an actual high-end system. Furthermore, multiple instantiations of both the simulation of the high-end system and the hardware partitioning application may be run simultaneously on the low-end system. Thus, multiple users may simultaneously have access to a software simulation of hardware that allows the actual hardware-partitioning software application to run on top of the simulation.

While embodiments of the present invention apply to running a hardware-partitioning software application on a simulation of another computer system, embodiments of the present invention are not so limited. Embodiments of the present invention are applicable to the more general concept of executing an application program on a first computer system that is simulating a second computer system. In this fashion, the application executes as if it were running on the actual hardware of the simulated system.

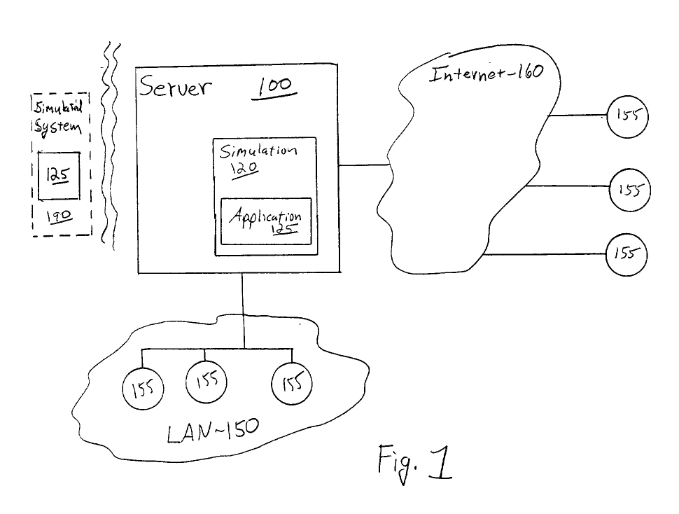

An embodiment of the present invention is a system for providing access to an application running on a computer simulation. Referring now to FIG. 1, the system comprises a first computing device 100. Throughout this description, the first computing device 100 may also be referred to as a server 100. The first computing device 100 has stored on it a simulation program 120 that is able to simulate a second computing device 190. FIG. 1 shows the simulated system 190 with application 125 on it, but it will be understood that it is there to indicate that the simulated system 190 is distinct from the first computing device 100.

In one embodiment, the first computing device 100 is a low-end computer system. The first computing device 100 may be selected based on the second computing device 190 that it is simulating. For example, the second or simulated computing device 190 may be a high-end computer system, although this is not required. In one embodiment, the simulated computing device 190 is a high-end server such as the Superdome system provided by Hewlett-Packard of Palo Alto, Calif. The first computing device 100 may be a low-end server, such as an A class server provided by Hewlett-Packard, although many other devices will suffice. In various embodiments, both the first computing device 100 and second computing device 190 are UNIX machines.

The first computing device 100 is able to execute a software application 125 that normally executes on the simulated computing device 190. In one embodiment, the application 125 is a hardware partitioning application 125. Because the hardware environment is simulated, the instance of the hardware partitioning application 125 does not manage real hardware partitions. Thus, it does not affect the actual configuration of the first computing device 100 on which it is running. However, all of the functions and screens that would be available if the application 125 were running on the simulated computing device 190 may be available in the simulated environment. This allows for easy training of system administrators and also makes an effective sales tool.

The first computing device 100 is also able to grant access to multiple users simultaneously to separate instantiations of the simulation program 120 and the application 125. In this fashion, the software applications 125 appear to the users to be executing on the users' own actual versions of the second computing device 190. The first computing device 100 may allow access to local users. For example, users at their own nodes 155 (e.g., they have their own personal computer) may be connected to the first computing device 100 via a local area network (LAN) 150 or the like.

The first computing device 100 may also grant remote users access to the simulated environment. For example, users at a number of remote nodes 155 are shown in FIG. 1 accessing the first computing device 100 via the Internet 160. In this fashion, a user running a conventional personal computer and a conventional web-browser may login to the first computing device 100 and access the simulation program 120 with the actual application 125 running on top of it. The exact same binaries of the application 125 that would run on the hardware of the device being simulated 190 may be executed on the simulated version running on the first computing device 100. In this fashion, the remote users appear to have access to the actual application 125 running the actual hardware of the simulated computer device 190. Web-accessibility may be something in common with the case if the application 125 were executing on the actual hardware of the simulated computing device 190. However, there may be some differences.

One of those differences may be that upon accessing the first computing device 100, a screen may appear that prompts the user for a user name and password. These may be stored such that this user's work may be saved so that upon returning the user may continue to work with a particular configuration that the user created. A further difference is that at some point the user may also be warned that what is or will be running is a demonstration/simulation of application program 125 running an a simulated computing device 190. The user may furthermore be informed that the actual performance of the simulation may be different than if running on an actual system. Also, as each user has their own instantiation, they may be prompted that what they do will not affect other users.

Some further differences between the simulated experience of embodiments of the present invention and running the application 125 on actual hardware, an opening screen may have a number of links to follow, which may not occur if the user were running the application 125 on an actual system. One link may be a ‘run partition manager’ link, which may be used to start execution of an instantiation of application 125. The user may experience this within the window of a conventional web-browser or a window outside of the browser. As stated herein, this may be an application 125 that the user is interested in learning how to use, for example, it may be a hardware partition program. A ‘control simulator’ link may be for bringing up a control simulator interface that allows a change to the configuration of the computer system being simulated. These may be changes that are not normally a part of the hardware partition application 125, but affect its use. Configuration changes may include changing how many of a given component are in the simulated system, performing an action on a component, and changing the specific type of a component. For example, cabinets may be added/subtracted to go from simulating a 32-way system to a 64-way system or vice versa. Also, the number of cells, I/O cards, chassis, etc. may be altered. Or, an action may be performed on one or more components, such as rebooting partitions or powering on/off cells. Still further examples of configuration changes include changing the type of component, such as changing the CPU type.

Still referring to what the user may see upon first accessing the server 100, there may also be a ‘configure browser’ link for installing a run-time environment. For example, an embodiment of the present invention runs in a Java environment. There may also be links to technical references, and help. Furthermore, a link may be available to download a presentation (e.g., a slide presentation) of the partition manager application 125.

The computer system that is being simulated may comprise a number of cabinets that may be cabled together. A complex may be defined as the sum of all hardware resources in and attached to one or more cabinets that are cabled together. The term complex may be used to refer to a single hardware configuration that can support multiple instances of an operating system by means of partitions. A partition may be a configuration of cells (e.g., processors and memory), and one or more I/O chassis. An I/O chassis may have slots that may contain I/O cards that connect the partition to peripheral devices.

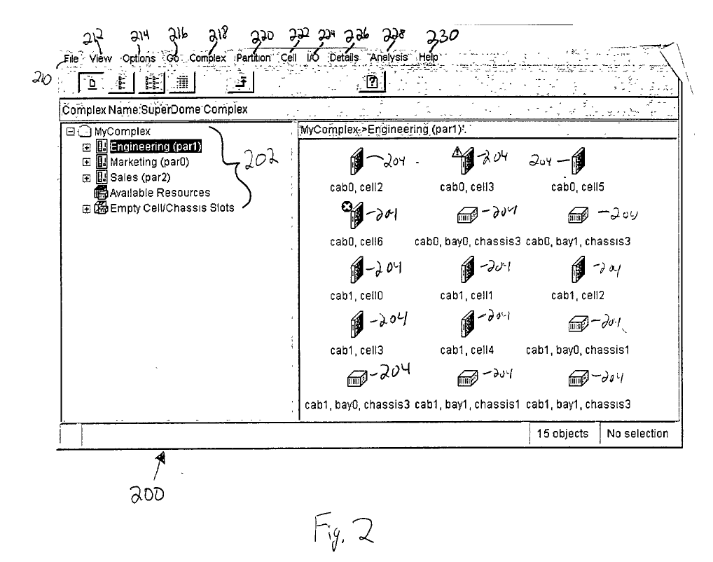

FIG. 2 illustrates an exemplary screen 200 showing a complex 202. In particular, the left hand side of the screen 200 shows that the complex 202 is divided into three partitions, engineering (par1), marketing (par0), and sales (par2). There are also available resources, which may be added to a partition or used to form a new partition. Further, there are empty cells and chassis slots, which are either empty or blocked from use. A user may use a computer mouse or the like to click on an item in the complex 202 on the left of the screen. For example, the user may select a partition to see its hardware elements. The right portion of the screen 200 illustrates the portion of the complex that defines the engineering partition. For example, 15 objects 204 are displayed defining the cells and chassis that are used for the engineering partition. The location of a cell may be specified by reference to a cabinet (cab) and cell. The location of a chassis may be specified by reference to a cabinet, bay, and chassis.

Embodiments of the present invention allow the user to modify and control the simulated configuration. For example, the control simulator interface may be used to perform actions that are normally done outside of the partition manage application 125 (e.g., using a console terminal). One exemplary action includes partition actions, such as shutting down all cells in a partition without automatically rebooting and simulating a partition reboot. Other exemplary actions include cell actions, such as simulating a cell performing a power on self-test, powering on a cell, and powering of a cell. Because these actions are simulations, considerable time and effect is saved and thus, embodiments of the present invention serve as effective teaching and sales tools.

Still referring to FIG. 2, a menu bar at the top of the screen 200 provides a pull-down menu of actions that can be performed from the current screen 200. The actions that are enabled may depend on which level of the object list is currently selected, and which item, if any is selected on the right pane of the screen 200. Menu actions perform functions such as adding new objects 204 to a level or modifying existing objects 204. Some actions may be enabled in more than one context. For example, actions affecting the entire complex 202 can generally be invoked from any sub-level screen.

The menu bar may contain two types of menus. Display management menus may be provided by the underlying windowing system and my function analogously to other applications using a windowing system. Examples of such may be the file sub-menu 210, view sub-menu 212, option sub-menu 214, and go sub-menu 216. However, task menus perform actions that may be specific to the application 125.

Still referring to FIG. 2, the menu bar contains a complex sub-menu 218 for actions that affect an entire complex, a partition sub-menu 220 for actions that affect the currently selected partition, a cell sub-menu 222 for actions that affect the currently selected cell, an I/O sub-menu 224 for actions that affect the currently selected I/O chassis or I/O card. For example, I/O cards may be added to empty slots, removed, or swapped. Since this is a simulation, of course the I/O card is not physically added. Thus, considerable time is saved for the student or customer, as simulating the replacement only takes a few seconds. Furthermore, the action alert screen describes in detail what would be happening in a real system. For example, it describes the various LEDs, power state, etc.

Still referring to the task sub-menus in FIG. 2, the details sub-menu 226 shows details on the complex, available resources, or the currently selected object. The analysis sub-menu 228 may be for executing partition manager problem detection, to determine the overall health of the complex. The help sub-menu 230 may be for accessing online help.

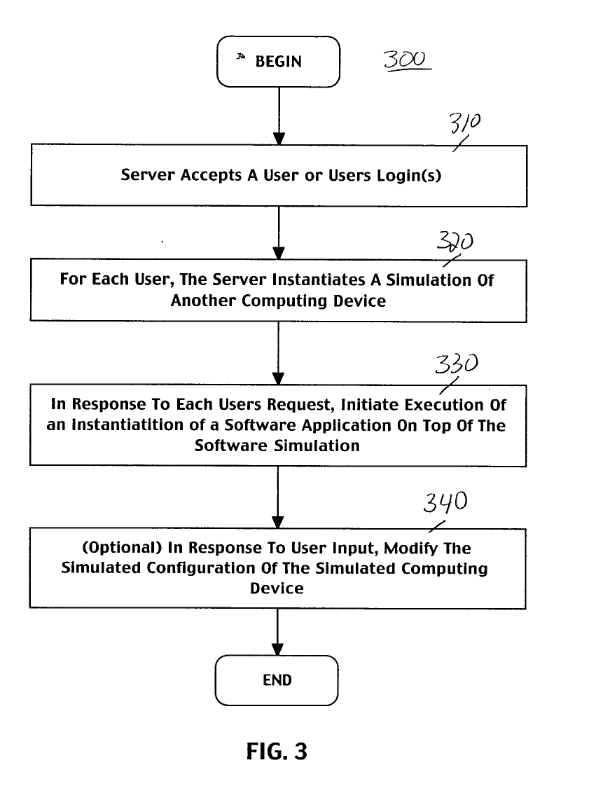

An embodiment of the present invention provides for a method of providing access to an application 125 running on a simulation of a computing device. Referring now to process 300 in FIG. 3, in step 310, the server 100 receives logins from one or more users. These may be local (e.g., from LAN 150) or remote (e.g., from Internet 160).

In step 320, the server 100 instantiates a separate simulation 120 of another computing device for each user. For example, the server 100, which may be a low-end server, instantiates a simulation 120 of a high-end server.

In step 330, the server 100 instantiates and begins execution of the application 125 on top of the simulation 120, such that to the user it appears that the application 125 is running on the hardware of the computing device being simulated 190.

In optional step 340, the server 100 responds to a request to re-configure the device being simulated by modifying the configuration of the device being simulated 190. For example, cabinets are added, partitions are re-booted, etc.

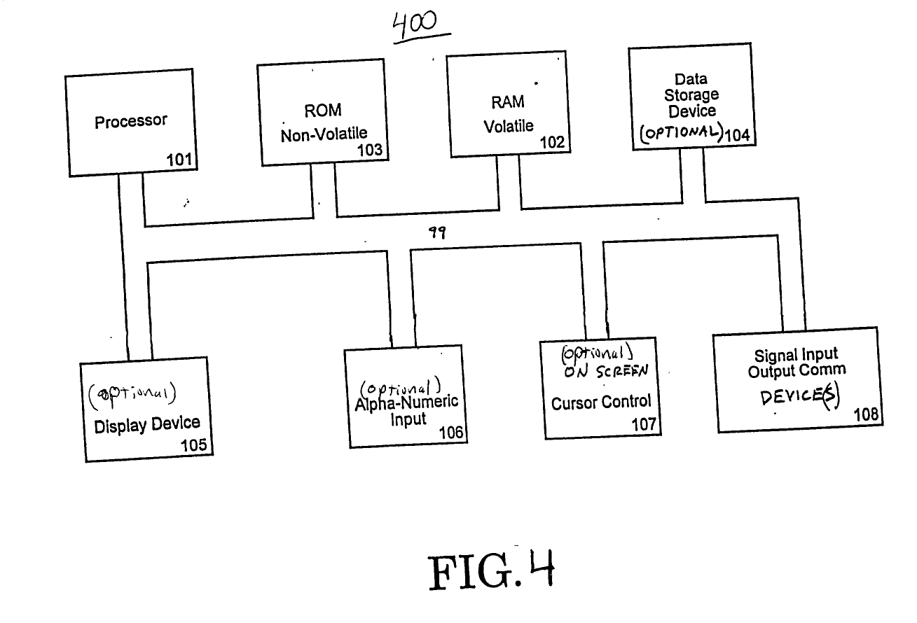

With reference now to FIG. 4, portions of embodiments of the present invention are comprised of computer-readable and computer-executable instructions that reside, for example, in computer-usable media of a computer system. For example, computer system 400 may be used as a platform for server 100. FIG. 4 illustrates an exemplary computer system 400 used to perform a method in accordance with embodiments of the present invention. It is appreciated that system 400 of FIG. 4 is exemplary only in that embodiments of the present invention can operate within a number of different computer systems including general purpose networked computer systems, embedded computer systems, and stand alone computer systems. Additionally, computer system 400 of FIG. 4 is well adapted to having computer readable media such as, for example, a floppy disk, a compact disc, and the like coupled thereto. Such computer readable media is not shown coupled to computer system 400 in FIG. 4 for purposes of clarity.

System 400 of FIG. 4 includes an address/data bus 99 for communicating information, and a central processor unit 101 coupled to bus 99 for processing information and instructions. Central processor unit 101 may be PA-RISC-family microprocessor. System 400 also includes data storage features such as a computer usable volatile memory 102, e.g., random access memory (RAM), coupled to bus 99 for storing information and instructions for central processor unit 101, computer usable non-volatile memory 103, e.g. read only memory (ROM), coupled to bus 99 for storing static information and instructions for the central processor unit 101, and an optional data storage unit 104 (e.g., a magnetic or optical disk and disk drive) coupled to bus 99 for storing information and instructions.

With reference still to FIG. 4, system 400 of embodiments of the present invention also includes an optional alphanumeric input device 106 including alphanumeric and function keys is coupled to bus 99 for communicating information and command selections to central processor unit 101. System 400 also optionally includes a cursor control device 107 coupled to bus 99 for communicating user input information and command selections to central processor unit 101. System 400 of the present embodiment also includes an optional display device 105 coupled to bus 99 for displaying information. Signal input/output communication device(s) 108 coupled to bus 99 is connected to a network (e.g., LAN 150, Internet 160) and controls the flow of information over the network.

While the present invention has been described in particular embodiments, it should be appreciated that the present invention should not be construed as limited by such embodiments, but rather construed according to the below claims.

We claim:

1. A system for providing access to an application running on a computer simulation, comprising:
a first computing device having a simulation program for simulating a second computing device;
said first computing device for executing, on said simulation program, a software application that normally executes on hardware of said second computing device; and
wherein said first computing device is further for granting simultaneous access to multiple users to separate instantiations of said simulation program and said software application.

2. The system of claim 1, wherein said first computing device is a server, wherein said multiple users access said first computing device via a web connection.

3. The system of claim 1, wherein said first computing device is a low-end computer.

4. The system of claim 1, wherein said second computing device is a high-end computer.

5. The system of claim 1, wherein said software application executing on said simulation program is a partition software application for partitioning said second computing device.

6. The system of claim 1, wherein said software application executing on said simulation program is a hardware partition application for hardware partitioning said second computing device.

7. The system of claim 1, wherein said simulation of said second computing device is re-configurable to allow the configuration of said second computing device to be altered.

8. The system of claim 7, wherein said alteration comprises changing the number of components of a given type in said second computing device.

9. The system of claim 7, wherein said alteration comprises performing an action on a component in said second computing device.

10. The system of claim 7, wherein said alteration comprises changing the type of a component in said second computing device.

11. A method of providing access to a software simulation, comprising:
a) accepting a user login to a first computing device;
b) instantiating a software simulation of a second computing device on said first computing device; and
c) in response to a user request, initiating execution of a software application on said software simulation of said second computing device.

12. The method of claim 11, wherein said a) comprises allowing a web-based connection to said first computing device.

13. The method of claim 11, further comprising:
d) instantiating multiple copies of said software simulation, in response to plurality of user logins; and
e) in response to a plurality of user requests, initiating execution of multiple instantiations of said software application on said multiple copies of said software simulation.

14. The method of claim 11, further comprising:
d) in response to user input, modifying said software simulation of said second computing device by modifying a simulated configuration of said second computing device.

15. The method of claim 14, wherein said modification is selected from the group consisting of: adding or removing a cabinet, rebooting a partition, powering on or off a cell, altering the number of cells, altering the number of I/O cards, altering the number of chassis, and changing the CPU type.

16. The method of claim 11, wherein said software application executing on said software simulation is a partition software application for partitioning said second computing device.

17. The method of claim 11, wherein said software application executing on said first computing device is a hardware partition software application for hardware partitioning said second computing device.

18. A web-based system for providing access to an application running on a computer simulation, comprising:
a web-based server;
a software simulation program for simulating a high-end computing device;
an application program that is designed to execute on said high-end computing device executing on said simulation software program; and
wherein said web-based server is accessible by a plurality of users executing their own instantiations of said software application executing on separate instantiations of said simulation program, wherein said instantiations of said software application appear to be executing on said users own versions of said high-end computing device.

19. The system of claim 18, wherein said web-based server is a low-end UNIX computing device.

20. The system of claim 19, wherein said high-end computing device is a high-end UNIX computing device.

21. The system of claim 20, wherein said application program is a hardware partition software application for hardware partitioning said high-end UNIX computing device.

22. The system of claim 19, wherein said simulation of said high-end computing device is re-configurable to allow its configuration to be changed.

23. The system of claim 20, wherein said configuration change comprises altering the number of one or more types of components.

24. The system of claim 20, wherein said configuration change comprises re-booting a partition.

25. The system of claim 20, wherein said configuration change comprises powering on or off a cell.
